(19) United States
(12) Patent Application Publication
(10) Pub. No.: US 2006/0019169 A1
(43) Pub. Date: Jan. 26, 2006

(54) Separators for electochemical devices having an Ionically conductive solid compound therein

(76) Inventors: W Novis Smith, Philadelphia, PA (US); Joseph B Kejha, Meadowbrook, PA (US)

Correspondence Address: Zachary T Wobensmith III, 6091 Carversville Wismen road, P O Box 370, Pipersville, PA, 18947-0370, US

(21) Appl. No.: 10/532,700

(22) PCT Filed: Oct. 30, 2002
(86) PCT No.: PCT/US02/34875

§ 371 Date: Apr. 26, 2005

(51) Int. Cl. H01M 10/40

(52) U.S. Cl. 429/303; 429/199

(57) ABSTRACT

Separators for electrochemical devices, which devices have a polymer gel electrolyte separator with an ionically conductive fluoride based solid compound, or a solid state separator with an electrolyte and an ionically conductive fluoride based solid compound.

### BACKGROUND OF THE INVENTION

1. Field of the Invention

This invention relates to separators for electrochemical devices which have a separator constructed of a gelled polymer, or a solid state separator which contains a liquid electrolyte and a solid, ionically conductive fluoride based compound.

2. Description of the Prior Art

Prior art separators for electrochemical devices, and for example lithium-ion polymer batteries use gelled polymer electrolyte separators, or microporous polyoleofin separators, or ceramic porous separators soaked in a non-aqueous liquid electrolyte to transport the liihium ions between their electrodes.

Examples of such separators are shown in U.S. Pat. Nos. 5,587,253; 5,871,863; 6,207,720B1; and 6,395,428B1, but none of them contains an ion-conductive solid compound.

The prior art gelled polymer electrolyte separators, or ceramic separators are usually welded, or glued, or fused to the electrodes to form a cell, and the microporous separators are usually pressed against the electrodes by an outer cell housing.

All of the above prior art separators are electronically insulating. The insulating polymeric or ceramic materials of these separators are also ionically non-conductive. Ionic conductivity is achieved only by jonically conductive liquids or liquid electrolytes contained in the separators' pores or in the gels. These liquids include at least one lithium salt, and are usually mixtures of cyclic carbonates, alkyl carbonates and/or ethers.

The addition of a solid, ionically conductive compound results in a structure that provides many positive advantages not found in the prior art structures.

### SUMMARY OF THE INVENTION

It has now been found that the ionic conductivity of various electrochemical devices can be improved by constructing gelled polymer or solid state separators, containing in addition to the ionically conductive liquids or liquid electrolytes, a solid, ionically conductive compound such as lithium fluoride, magnesium fluoride, sodium fluoride or other solid fluorides, depending on the chemistry of the devices used.

These compounds also add strength and heat resistance to the polymer gel structure, which structure thus better resists a compression load, preventing electrical shorting of the cells, and the gelled polymer separator may be made thinner than the prior art separators, which increases the energy density of the cells, and may also be used as a carrier for the cells in the assembly process due to its improved tensional strength. Other insoluble, ion-conductive compounds may be similarly used. The main benefit of these compounds is in the improved ionic conductivity and cycling stability of the cells.

The principal object of the invention is to provide separators for electrochemical devices, which include a solid, ion-conductive fluoride based compound.

A further object of the invention is to provide separators of the character aforesaid, which provide improved ionic conductivity and cycling stability for the devices in which they are incorporated.

A further object of the invention is to provide separators of the character aforesaid which result in the devices in which they are incorporated having low resistance and flat capacity curve.

A further object of the invention is to provide separators of the character aforesaid, which provide increased compressive strength and heat resistance to the electrochemical devices in which they are incorporated.

A further object of the invention is to provide separators of the character aforesaid may be welded, or glued to the electrodes, or held in place against the electrodes by compression.

A further object of the invention is to provide separators of the character aforesaid which are particularly suitable for mass production.

Other objects and advantageous features of the invention will be apparent from the description and claims.

It should, of course, be understood that the description herein is merely illustrative and that various modifications, combinations and changes can be made in the separators disclosed without departing from the spirit of the invention.

### DESCRIPTION OF THE PREFERRED EMBODIMENTS

When referring to the preferred embodiments, certain terminology will be utilized for the sake of clarity, Use of such terminology is intended to encompass not only the described embodiment, but also technical equivalents, which operate and function in substantially the same way to bring about the same result.

An electrochemical device, such as a lithium cell (not shown) typically includes an anode and a current collector in contact with the anode, a cathode and a current collector in contact with the cathode, and separator and an electrolyte of well-known type, in contact with the anode and cathode, and the whole assembly is contained in a moisture proof enclosure, with exiting sealed terminals.

The separator for use in this type of cell can be a solid-state separator with a liquid electrolyte or a polymer gel electrolyte containing an ionically conductive liquid.

Various solid fluorides, and for example lithium fluoride (LiF), sodium fluoride (NaF), or magnesium fluoride (MgF₂) may be added in the preferable range of 10% to 85% by weight into the polymer gel electrolyte, or 10% to 90% by weight into the solid-state separator with a liquid electrolyte, depending on the chemistry of the devices used.

The described separators with LiF may be used in lithium based electrochemical devices, and are welded or glued to the electrodes, or they may be just sandwiched between the electrodes and held in place by an outside housing, such as used in liquid electrolyte type devices.

Various examples of polymer gel electrolytes and solid state separators were constructed.

### EXAMPLE 1

A polymer gel electrolyte separator with a solid, ion-conductive supplemental compound was prepared by mixing 50% LiF powder; 25% PVDF/HFP 2801 (Atofina); and 25% high boiling point plasticizer liquid by weight (%) in acetone solvent at 50° C., in a closed bottle. The fliure was cast onto a polyester film using a doctor blade. The acetone was allowed to evaporate, and the resulting tough film layer was peeled off. The plasticizer liquid was extracted from the layer in a methanol bath and the film layer was vacuum dried. The resulting tough and porous film was soaked under an argon atmosphere with a well known electrolyte containing one mole LiTF₆ salt to form a gelled polymer electrolyte separator and was assembled into a lithium-ion cell. The cell had an unusually stable and flat capacity curve, maintaining substantially the same capacity over 200 cycles at C/2 rate.

### EXAMPLE 2

A polymer gel electrolyte separator with a solid, ion-conductive supplemental compound was prepared under argon atmosphere by mixing 50% LiF powder, 25% PVDF/HFP 2801 (Atofina) and 25% by weight electrolyte, comprising 2 mole LiBF₄ salt in 80% ethylene carbonate (EC) and 20% gamma butyrolactone, all in dimethoxy ethane (DME) solvent, at 50° C.; in a closed bottle.

The mixture was cast onto a polyester film by a doctor blade under an argon atmosphere. The DME was allowed to evaporate and the resulting gel polymer electrolyte film was peeled off, cut to desired size and used in a lithium cell as the separator. Similar results as in Example 1 were achieved.

### EXAMPLE 3

A solid state separator with the solid ion-conductive supplemental compound was prepared by mixing in acetone, 90% LiF powder and 10% PVDF/HFP 2801 (ATOFINA) by weight at 50° C., in a closed bottle.

The mixture was cast onto a porous electrode by a doctor blade. The acetone was allowed to evaporate to form a solid porous layer, A second porous electrode was added on top of the layer and was heat-fused under pressure to the solid porous layer to form a cell. The cell was vacuum dried and then soaked (activated) under an argon atmosphere by a well-known electrolyte, sealed in a housing and was stably rechargeable.

These separators with LiF compound may also be used in other libium based electrochemical devices, such as capacitors, ultcapacitors, hybrid pseudocapacitors and lithium primary batteries, The polymers used in this invention are not limited to the polyvinylidene fluoride/hexafluoropropylene (PVDF/HFP) copolymer, but may be any suitable polymer, such as PVDF homopolymer, PEO, PAN, PVC, polyamide, their blends, copolymers and alloys.

The described ionically conductive, non-soluble, compounds such as LiF, NaF and MgF₂ may also be added to ceramic type separators, like Al₂O₃, SiO₂, MgO, or their mixtures, or other solid oxide based separators, in the preferred range of 5% to 90% by weight of the oxide. Similar benefits are obtained. In magnesium-ion based electrochemical devices, however, the LiF should be replaced by a MgF₂ compound, and in sodium-ion based electrochemical devices the LiF should be replaced by a NaF compound to match the selected electrochemistry and ion transport medium, Other insoluble, ion-conductive compounds may be similarly used, The main benefit of these compounds is in the improved ionic conductivity and cycling stability of the cells.

It will thus be seen that separators have been provided with which the objects of the invention are achieved.

We claim:

1. A polymer gel electrolyte separator for electrochemical devices which comprises:
a polymeric matrix;
an ionically conductive solid compound; and
a liquid electrolyte containing at least one salt.

2. A solid state separator for electrochemical devices which comprises;
an ionically conductive solid compound;
a polymeric binder; and
a liquid electrolyte containing at least one salt.

3. A polymer gel electrolyte separator for electrochemical devices which comprises:
a polymeric matrix;
a solid metal oxide;
an ionically conductive solid compound; and
a liquid electrolyte, containing at least one salt.

4. A solid state separator for electrochemical devices which comprises:
a solid metal oxide;
an ionically conductive solid compound;
a polymeric binder, and
a liquid electrolyte, containing at least one salt.

5. A polymer gel electrolyte separator as described in claim 1 or 3, in which said ionically conductive solid compound is selected from the group consisting of lithium fluoride, magnesium fluoride and sodium fluoride.

6. A solid state separator as described in claim 2 or 4, in which said ion-conductive solid compound is selected from the group consisting of lithium fluoride, magnesium fluoride and sodium fluoride.

7. A separator as described in claim 5, in which said fluorides are in the range of 10% to 85% by weight.

8. A separator as described in claim 6, in which said fluorides are in the range of 10% to 90% by weight.

9. A separator as described, in claim 1 or 2 or 3 or 4 in which said electrochemical devices are lithium based batteries, sodium based batteries, magnesium based batteries, capacitors, ultracapacitors and hybrid pseudocapacitors.

10. A separator as described in claim 9, in which said lithium based batteries are lithium-ion batteries.
